(19) United States
(12) Patent Application Publication
(10) Pub. No.: US 2026/0316861 A1
(43) Pub. Date: Oct. 15, 2026

(54) RECOIL DEVICE AND TRACKED VEHICLE

(71) Applicant: Caterpillar SARL, Geneva (CH)

(72) Inventors: Seiji IIJIMA, Akashi (JP); Yasuo YAMASHITA, Akashi (JP); Yu MATSUMOTO, Akashi (JP)

(21) Appl. No.: 19/484,060

(22) PCT Filed: May 10, 2024
(86) PCT No.: PCT/EP2024/025160

§ 371 Date: Nov. 13, 2025

(30) Foreign Application Priority Data
May 16, 2023 (JP) 2023-080685

(51) Int. Cl. B62D 55/30; B62D 55/112

(52) U.S. Cl. CPC B62D 55/30; B62D 55/112

(57) ABSTRACT

Problem: Provide a recoil device that can prevent damage to the accumulator. Solution: A recoil device that buffers impact received by a track comprises a cylinder tube that stores liquid, a piston rod slidably mounted on to one end of the cylinder tube, an accumulator connected to the other end of the cylinder tube, and a cover member that protects the accumulator.

### TECHNICAL FIELD

The present invention relates to a recoil device for buffering impact received by a track, and to a tracked vehicle comprising a recoil device

### BACKGROUND

A tracked vehicle, such as a hydraulic shovel or bulldozer, includes a track frame, a sprocket disposed on one end of the track frame, an idler disposed on the other end of the track frame, a track wrapped around the sprocket and the idler, and a recoil device that buffers the impact received by the track.

There are various forms of recoil devices mounted on tracked vehicles. For example, the recoil device may be in the form of a cylinder tube for storing liquid, a piston rod slidably mounted on one end of the cylinder tube, and an accumulator connected to the other end of the cylinder tube (see, for example, Patent Document 1).

The cylinder tube of the recoil device is fixed to the track frame. The piston rod is connected to the idler via an idler yoke that rotatably supports the idler. In addition, a bladder filled with a gas such as nitrogen gas is provided inside the accumulator.

In the above recoil device, when the track is impacted, the idler yoke moves with the idler toward the sprocket. Thus, this pushes the piston rod connected to the idler into the cylinder tube. The fluid then flows from the cylinder tube to the accumulator. As a result, the impact is buffered by compressing the gas in the bladder.

After the impact is buffered, liquid flows from the accumulator to the cylinder tube as the bladder is restored by the pressure of the compressed gas. As a result, the piston rod returns to its initial position, and the idler also returns to its initial position, whereby a predetermined tension is applied to the track.

### PRIOR ART DOCUMENTS

### Patent Document

Patent Document 1: JP2003-343516A

### SUMMARY OF THE INVENTION

### Problems to be Solved by the Invention

However, in the recoil device disclosed in Patent Document 1, the accumulator is exposed, so there is a risk that the accumulator may be damaged by soil and sand.

An upper part of the accumulator is partially covered by the track frame, but a hole is formed in a top surface of the track frame to prevent soil and sand from depositing on the top surface of the track frame. Therefore, the soil and sand that falls out of the hole may fall on the accumulator.

In addition, since an underside of the accumulator is exposed, the soil and sand may fly toward the accumulator while the tracked vehicle is traveling.

Therefore, in the aforementioned recoil device, there is a high risk that the accumulator will be damaged by the soil and sand.

An object of the present invention is to provide a recoil device and a tracked vehicle capable of preventing damage to an accumulator.

### Means for Solving the Problem

According to this invention, there is provided a recoil device as follows which solves the above technical problem. That is, it provides “A recoil device for buffering impact received by a track, the recoil device comprising:
a cylinder tube for storing liquid;
a piston rod slidably mounted on one end of the cylinder tube;
an accumulator coupled to the other end of the cylinder tube; and
a cover member for protecting the accumulator.”

The cover member is preferably capable of adjusting a tension of the track by moving the cylinder tube and the piston rod.

The cover member includes a cylindrical fixed cover and a cylindrical movable cover slidably fitted to the fixed cover and connected to the cylinder tube, wherein a grease chamber for storing grease is formed between the fixed cover and the movable cover, wherein a tension of the track is adjusted by moving the movable cover relative to the fixed cover and by moving the cylinder tube and the piston rod due to an increase or decrease in an amount of grease in the grease chamber.

Desirably, the recoil device of the present invention further comprises a stroke adjustment means for adjusting the movable distance of said piston rod.

Preferably, the stroke adjustment means is movably and threadably coupled to the piston rod or the cylinder tube, and a movable distance of the piston rod is preferably changed by changing the position of the stroke adjustment means.

A male thread is formed in the stroke adjustment means and a female thread is formed in the piston rod, and the stroke adjustment means may be movably and threadably coupled to the piston rod by fitting the male thread and the female thread.

It is advantageous that a male thread is formed in the cylinder tube and a female thread is formed in the stroke adjustment means, and the male thread and the female thread are fitted so that the stroke adjustment means are movably and threadedly coupled to the cylinder tube.

The stroke adjustment means may be a spacer fixed to the piston rod or the cylinder tube.

According to this invention, there is provided a tracked vehicle as follows which solves the above technical problem. In other words, it provides “A tracked vehicle comprising the recoil device, the tracked vehicle comprising:
a track frame, a sprocket disposed at one end of the track frame, an idler disposed at the other end of the track frame, and an idler yoke rotatably supporting the idler;
wherein one of the idler yoke and the piston rod is formed with a concave surface; and
the other of the idler yoke and the piston rod is formed with a convex surface corresponding to the concave surface;
the concave surface and the convex surface are in contact such that a position of the idler yoke relative to the piston rod is freely changeable.”

The concave surface and the convex surface are both preferably spherical. An annular protrusion may be provided around the concave surface.

### Effect of the Invention

In the present invention, since the accumulator is protected by the cover member, damage to the accumulator can be prevented.

### BRIEF DESCRIPTION OF DRAWINGS

FIG. 1 is a side view of a traveling body of a tracked vehicle according to the present invention.

FIG. 2 is an exploded perspective view of a portion of the traveling body shown in FIG. 1;

FIG. 3 is a perspective view of the recoil device, idler and idler yoke shown in FIG. 1;

FIG. 4 is a cross section view of the recoil device shown in FIG. 1;

FIG. 5 is an enlarged view (piston rod side) of FIG. 4;

FIG. 6 is an enlarged view (accumulator side) of FIG. 4;

FIG. 7 is a cross section view of the recoil device shown in FIG. 1 with the movable distance of the piston rod reduced;

FIG. 8 is a plan view showing a state in which the position of the idle yoke is offset with respect to the piston rod shown in FIG. 1 (wherein the idle yoke is shown in cross section);

FIG. 9 is a cross section view of a recoil device having a first variant of a stroke adjustment means;

FIG. 10 is a cross section view of a recoil device having a second variant of a stroke adjustment means;

FIG. 11 is a cross section view of a recoil device having a third variant of a stroke adjustment means.

### DETAILED DESCRIPTION OF EMBODIMENTS

Now, embodiments of the recoil device according to the present invention will be described with reference to the drawings above.

### Traveling Body 2

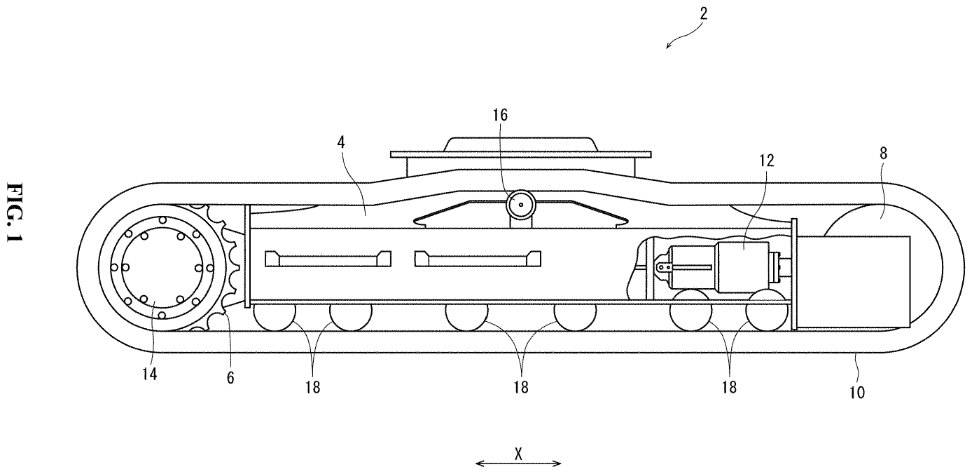

In FIG. 1, a traveling body 2 of a hydraulic shovel is described as an example of a traveling body of a tracked vehicle. The travelling body 2 includes a track frame 4, a sprocket 6 disposed on one end (a left side in FIG. 1) of the track frame 4, an idler 8 disposed on the other end (a right side in FIG. 1) of the track frame 4, a track 10 wrapped around the sprocket 6 and the idler 8, and a recoil device 12 that buffers impact received by the track 10.

The sprocket 6, the idler 8, the track 10, and the recoil device 12 are provided in pairs at intervals in a direction perpendicular to the paper surface, but only one of each is described in FIG. 1. In addition, in FIG. 1, the track frame 4 is partially cut out so that the recoil device 12 can be seen for convenience.

As shown in FIG. 1, the sprocket 6 is mounted with a hydraulic motor 14. As the sprocket 6 rotates by this hydraulic motor 14, the track 10 rotates. As a result, the tracked vehicle equipped with the traveling body 2 is driven. Also, when the track 10 rotates, in addition to the idler 8, the track 10 is guided by the carrier roller 16 and the track roller 18.

### Idler Yoke 20

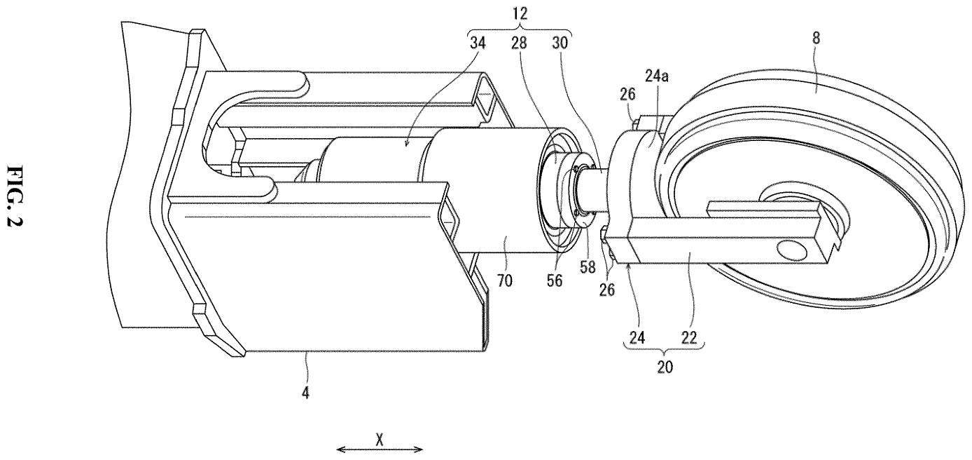

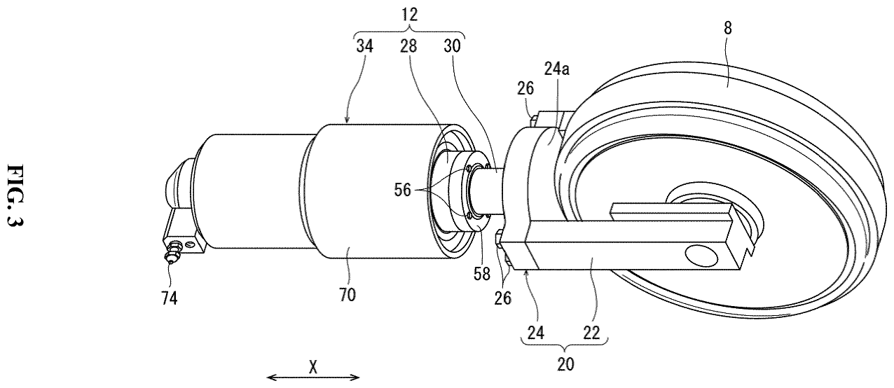

Referring to FIGS. 2 and 3, the idler 8 is mounted on the track frame 4 via the idler yoke 20. The idler yoke 20 has a pair of support rods 22 that rotatably support the idler 8, and a connecting piece 24 that connects the ends of the pair of support rods 22 to each other.

The pair of support rods 22 of the idler yoke 20 are supported by the track frame 4 to move freely in a traveling direction (a direction indicated by an arrow X) of the travelling body 2. The pair of support rods 22 are fastened to one surface 24a of the connecting piece 24 by a plurality of bolts 26.

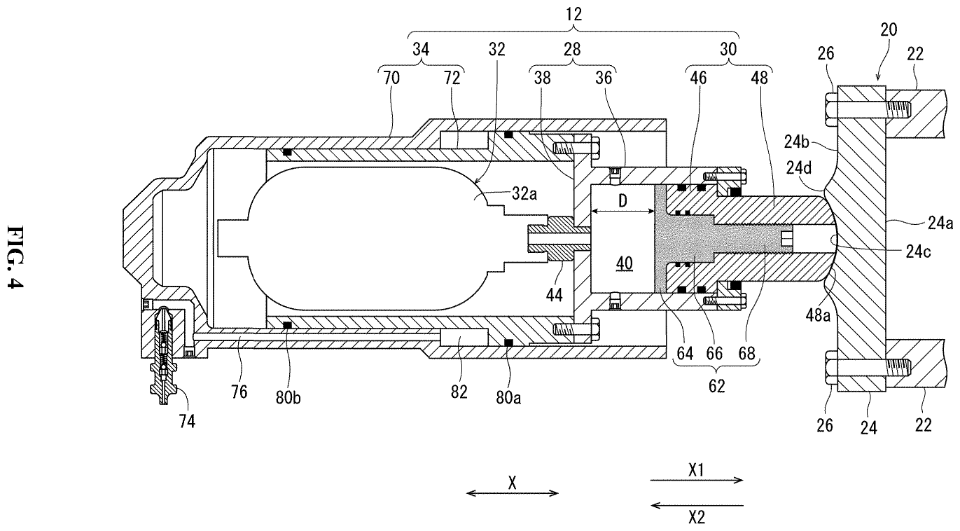

As shown in FIG. 4, a concave surface 24c is formed on the other surface 24b of the illustrated connecting piece 24. The concave surface 24c is preferably spherical. Also, an annular protrusion 24d may be provided around the concave surface 24c.

### Recoil Device 12

The recoil device 12 is disposed on the other surface 24b of the connecting piece 24. The recoil device 12 comprises a cylinder tube 28 that stores liquid such as oil, a piston rod 30 slidably mounted on one end of the cylinder tube 28, an accumulator 32 connected to the other end of the cylinder tube 28, and a cover member 34 that protects the accumulator 32.

### Cylinder Tube 28

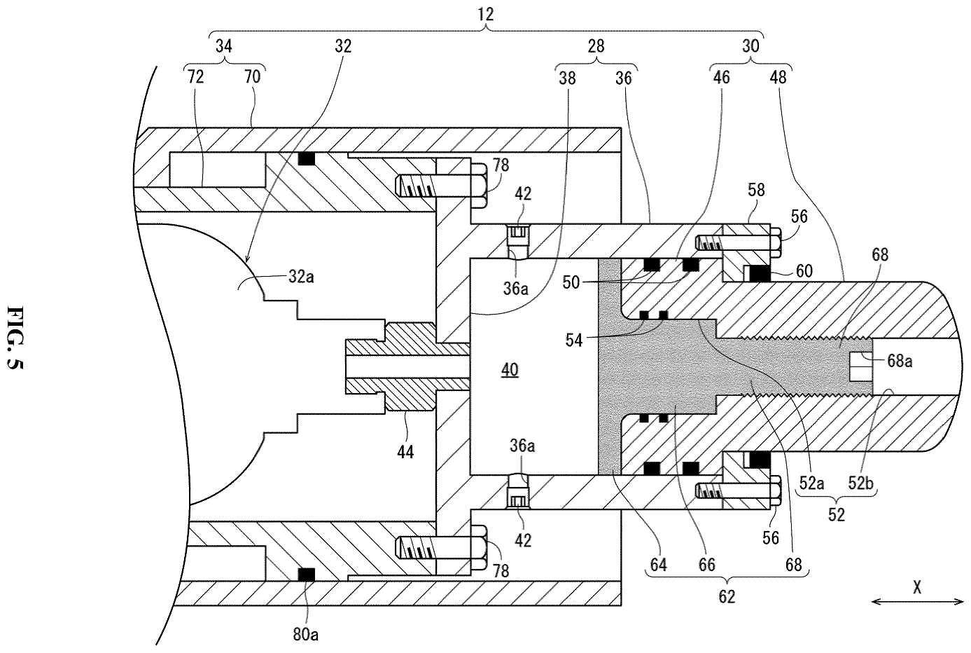

Referring to FIG. 5, the cylinder tube 28 has a cylindrical sidewall 36 extending in the X-axis direction and a circular end wall 38 provided at an end (left end of FIG. 5) of the sidewall 36 in the X-axis direction. The diameter of the illustrated end wall 38 is larger than the diameter (outer diameter) of the sidewall 36, with a peripheral edge of the end wall 38 protruding from an outer peripheral surface of the sidewall 36. In the cylinder tube 28, the sidewall 36 and the end wall 38 define a liquid chamber 40 for storing liquid.

A pair of openings 36a are formed in the sidewall 36 of the cylinder tube 28 for supplying liquid to and discharging liquid from the liquid chamber 40. Upon assembly of the recoil device 12, a predetermined amount of liquid is supplied from the opening 36a to the fluid chamber 40 so that the piston rod 30 is positioned in an initial position (the position shown in FIG. 5). After the piston rod 30 is positioned in the initial position, each of the pair of openings 36a is blocked by the plug 42.

As shown in FIG. 5, the end wall 38 of the cylinder tube 28 is mounted with a connector 44 for connecting the cylinder tube 28 and the accumulator 32. The fluid chamber 40 of the cylinder tube 28 and a fluid chamber (not shown) of the accumulator 32 are in communication with each other by means of the connector 44.

### Piston Rod 30

The piston rod 30 is disposed at one end of the cylinder tube 28 in the X-axis direction. The piston rod 30 includes a cylindrical piston 46 sliding in the X-axis direction within the cylinder tube 28 and a cylindrical rod 48 extending in the X-axis direction from the end face of the piston 46.

### Piston 46

The diameter (outer diameter) of the piston 46 is larger than the diameter (outer diameter) of the rod 48. Also, the diameter (outer diameter) of the piston 46 is substantially the same as the inner diameter of the sidewall 36 of the cylinder tube 28. An annular piston packing 50 is mounted on the outer circumferential surface of the piston 46. The piston packing 50 prevents liquid from leaking between the outer peripheral surface of the piston 46 and the inner peripheral surface of the sidewall 36 (a sliding portion). A plurality of piston packing 50 (e.g. two) may be provided at intervals in the X-axis direction.

### Rod 48

A tip of the illustrated rod 48 is formed with a convex surface 48a corresponding to the above-mentioned concave surface 24c. The convex surface 48a is preferably spherical. As shown in FIG. 4, the convex surface 48a at the tip of the rod 48 is in contact with the concave surface 24c of the connecting piece 24, such that the position of the idler yoke 20 relative to the piston rod 30 is changeable freely.

### Through Hole 52

As shown in FIG. 5, the piston rod 30 of the present embodiment is formed with a stepped through hole 52 extending in the X-axis direction. The through hole 52 has a large diameter portion 52a and a small diameter portion 52b having a smaller diameter than the diameter of the large diameter portion 52a. In FIG. 5, the large diameter portion 52a is located on the left side (the piston 46 side) and the small diameter portion 52b is located on the right side (the rod 48 side).

An annular packing 54 is provided in the large diameter portion 52a of the through hole 52. A plurality (e.g., two) of the annular packing 54 may be provided at intervals in the X-axis direction. A female thread extending along the X-axis direction is formed in the small diameter portion 52b of the through hole 52. No internal thread is formed in the large diameter portion 52a.

### Rod Cover 58

In this embodiment, the piston rod 30 is inserted into the cylinder tube 28 when the recoil device 12 is assembled. Thereafter, the end (the end opposite to the end wall 38) of the sidewall 36 of the cylinder tube 28 is fastened with an annular rod cover 58 by a plurality of bolts 56 (see FIG. 5).

This rod cover 58 is mounted on the cylinder tube 28 to prevent the piston rod 30 from escaping from the cylinder tube 28. Also, as shown in FIG. 5, the rod cover 58 is mounted with an annular rod packing 60 that suppresses the ingress of foreign matters into the interior of the cylinder tube 28.

### Stroke Adjustment Means 62

As shown in FIGS. 4 and 5, a cylindrical piston rod 30 may be mounted with a stroke adjustment means 62 to adjust a movable distance D of the piston rod 30. The stroke adjustment means 62 has a circular plate portion 64, a cylindrical body portion 66 extending in the X-axis direction from one side of the plate portion 64, and a cylindrical threaded portion 68 extending in the X-axis direction further from the tip of the body portion 66.

### Plate Portion 64

In the embodiment shown, the diameter of the plate portion 64 of the stroke adjustment means 62 corresponds to the diameter (outer diameter) of the piston 46. However, the diameter of the plate portion 64 may not correspond to the diameter of the piston 46. The shape of the plate portion 64 may also be other shapes (e.g., a rectangular shape) rather than the circular shape.

### Body Portion 66

The diameter of the body portion 66 of the stroke adjustment means 62 corresponds to the diameter of the large diameter 52a of the through hole 52, and the body portion 66 is positioned at the large diameter portion 52a. The gap between the outer peripheral surface of the body portion 66 and the inner peripheral surface of the piston 46 is blocked by the annular packing 54. This prevents liquid from leaking from the above gap.

### Threaded Portion 68

A male thread is formed on the outer peripheral surface of the threaded portion 68 of the stroke adjustment means 62 to fit into the female thread of the small diameter portion 52b of the through hole 52. The male thread of the threaded portion 68 is fitted with the female thread of the small diameter portion 52b so that the stroke adjustment means 62 is movably and threadedly coupled to the piston rod 30 in the X-axis direction. Also, a tool recess 68a (e.g., a hexagonal hole, a cross hole, a slot, etc.) is formed at the tip of the threaded portion 68.

### Accumulator 32

As shown in FIG. 4, the accumulator 32 is disposed on the other end (opposite to the piston rod 30) of the cylinder tube 28 in the X-axis direction. The accumulator 32 has a housing 32a connected to the end wall 38 of the cylinder tube 28 via the connector 44, and a bladder (not shown) housed within the housing 32a. Gas such as nitrogen gas is encapsulated inside the bladder.

### Cover Member 34

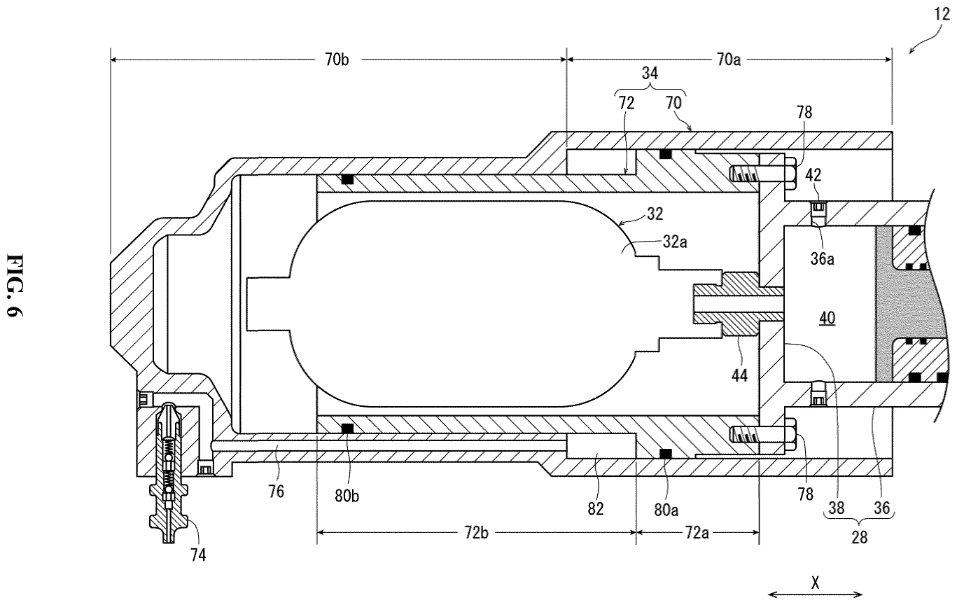

The cover member 34 will be described with reference to FIG. 6. The cover member 34 includes a cylindrical fixed cover 70 and a cylindrical movable cover 72 slidably fitted to the fixed cover 70.

### Fixed Cover 70

Although not shown, the fixed cover 70 is fixed to the track frame 4. That is, the position of the fixed cover 70 with respect to the track frame 4 is to remain unchanged.

The fixed cover 70 has a cylindrical shape extending in the X-axis direction, and one end of the fixed cover 70 in the X-axis direction (the right end in FIG. 6: an end on a side of the idler 8) is open. On the other hand, the other end of the fixed cover 70 in the X-axis direction (left end in FIG. 6: an end on a side of the sprocket 6) is occluded.

The inner peripheral surface of the fixed cover 70 is provided with a step. Specifically, the fixed cover 70 has a large diameter portion 70a and a small diameter portion 70b having a smaller inner diameter than the inner diameter of the large diameter portion 70a. In FIG. 6, the large diameter portion 70a is located on the right side (a side of the idler 8) and the small diameter portion 70b is located on the left side (a side of the sprocket 6).

A grease valve 74 is mounted to the small diameter portion 70b of the fixed cover 70. In addition, a grease passage 76 is formed in the small diameter portion 70b from the grease valve 74 to the large diameter portion 70a.

### Movable Cover 72

The movable cover 72 has a cylindrical shape extending in the X-axis direction. One end of the movable cover 72 in the X-axis direction (the right end in FIG. 6: the end on the side of the idler 8) is fastened to the end wall 38 of the cylinder tube 28 by a plurality of bolts 78.

The outer circumferential surface of the movable cover 72 is provided with a step. Specifically, the movable cover 72 has a large diameter portion 72a and a small diameter portion 72b having a smaller outer diameter than the outer diameter of the large diameter 72a. In FIG. 6, the large diameter portion 72a is located on the right side and the small diameter portion 72b is located on the left side.

The outer diameter of the large diameter portion 72a of the movable cover 72 is approximately the same as the inner diameter of the large diameter portion 70a of the fixed cover 70. Also, the outer diameter of the small diameter portion 72b of the movable cover 72 is substantially the same as the inner diameter of the small diameter portion 70b of the fixed cover 70. An annular packing 80a is mounted on the outer peripheral surface of the large diameter portion 72a of the movable cover 72, and an annular packing 80b is also mounted on the outer peripheral surface of the small diameter portion 72b of the movable cover 72.

### Grease Chamber 82

An annular grease chamber 82 storing grease is formed between the inner peripheral surface of the large diameter portion 70a of the fixed cover 70 and the outer peripheral surface of the small diameter portion 72b of the movable cover 72. The grease chamber 82 is in communication with the grease passage 76.

When the recoil device 12 is assembled to the travelling body 2, a predetermined amount of grease is supplied from the grease valve 74 to the grease chamber 82 via the grease passage 76. In this way, this positions the movable cover 72 in an initial position. In addition, the leakage of grease from the grease chamber 82 is prevented by the annular packing 80a, 80b.

As mentioned above, since the movable cover 72 is fastened to the cylinder tube 28, once the movable cover 72 is positioned in the initial position, the cylinder tube 28 and the piston rod 30 will also be positioned in the initial positions, and the idler yoke 20 and the idler 8 will also be positioned in the initial positions. As a result, a predetermined tension is applied on the track 10.

Further, in the embodiment shown, the movable cover 72 is fitted inside the fixed cover 70, but in contrast, the movable cover may be fitted outside the fixed cover. In this case, a grease chamber is formed between the outer peripheral surface of the fixed cover and the inner peripheral surface of the movable cover.

Next, the function of the recoil device 12 described above will be described.

### Buffering the Impact of Track 10

When the traveling body 2 is traveling on an uneven ground or the like, if the track 10 is impacted, the idler yoke 20 moves with the idler 8 toward the sprocket 6. The connecting piece 24 of the idler yoke 20 then pushes the piston rod 30 into the cylinder tube 28. This causes liquid to flow from the fluid chamber 40 of the cylinder tube 28 to the liquid chamber of the accumulator 32. As a result, the impact is buffered by the compression of the gas in the bladder of the accumulator 32.

After the impact is buffered, liquid flows from the liquid chamber of the accumulator 32 to the liquid chamber 40 of the cylinder tube 28 as the bladder is restored by the pressure of the compressed gas. This causes the piston rod 30 to press against the connecting piece 24 of the idler yoke 20 to move the idler 8 to the initial position as the piston rod 30 returns to the initial position. Thus, the above predetermined tension is applied to the track 10.

### Protection of Accumulator 32

In the recoil device 12 of the illustrated embodiment, the accumulator 32 is covered by the cover member 34 and the accumulator 32 is not exposed. Because of this, there is no soil and sand on the accumulator 32, and thus damage to the accumulator 32 is prevented.

### Adjustment of Tension of Track 10

As described above, the fixed cover 70 of the cover member 34 is fixed to the track frame 4. The movable cover 72 is also connected to the cylinder tube 28. Therefore, as the amount of grease in the grease chamber 82 increases, the movable cover 72 moves in the X1 direction (see FIG. 4) relative to the fixed cover 70. Along with this, the cylinder tube 28 and the piston rod 30 also move in the X1 direction, while the idler yoke 20 and the idler 8 also move in the X1 direction. As a result, the tension of the track 10 increases.

Conversely, as the amount of grease in the grease chamber 82 decreases, the cylinder tube 28 and the piston rod 30 move in the X2 direction because the movable cover 72 moves in the X2 direction relative to the fixed cover 70. As a result, the load applied to the idler 8 from the track 10 causes the idler 8 and the idler yoke 20 to move in the X2 direction, thus reducing the tension of the track 10.

In this way, in the recoil device 12, the tension of the track 10 may be adjusted by the movement of the movable cover 72 relative to the fixed cover 70 and the movement of the cylinder tube 28 and the piston rod 30 due to the increase or decrease of the amount of grease in the grease chamber 82. In short, the cover member 34 of the present embodiment is able to adjust the tension of the track 10 by moving the cylinder tube 28 and the piston rod 30.

### Adjustment of the Movable Distance D of the Piston Rod 30

Before assembling the recoil device 12 to the travelling body 2, a suitable tool fitting into the recess 68a (see FIG. 5) from the through hole 52 of the piston rod 30 is inserted into the through hole 52, and the stroke adjustment means 62 can be rotated with this tool to move the stroke adjustment means 62 relative to the piston rod 30 in the X-axis direction (the sliding direction of the piston rod 30).

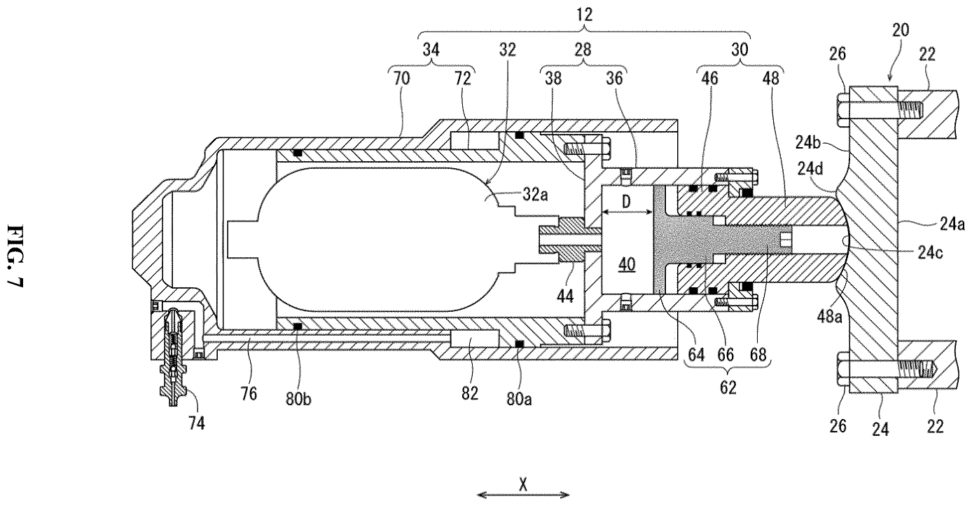

FIG. 4 shows a case where the plate portion 64 of the stroke adjustment means 62 is in contact with the piston 46 and the movable distance D of the piston rod 30 is adjusted to a maximum value. On the other hand, FIG. 7 shows a case where the stroke adjustment means 62 is moved to the left side (the side of the accumulator 32) and the movable distance D of the piston rod 30 is adjusted to a value lower than the maximum value than the case shown in FIG. 4.

Thus, by changing the position of the stroke adjustment means 62 in the X-axis direction, the movable distance D of the piston rod 30 in the cylinder tube 28 can be changed.

Thus, with the movable distance D of the piston rod 30, the filling pressure of the gas in the accumulator 32 can be adjusted suitably to change the rebound force when the track 10 is impacted. For this reason, the recoil device 12 may be carried on multiple tracked vehicles of different sizes and weights. The rebound force required when the track 10 is impacted is set to a value that varies depending on the size and weight of the tracked vehicle.

### Absorb the Deviation of Idler 8

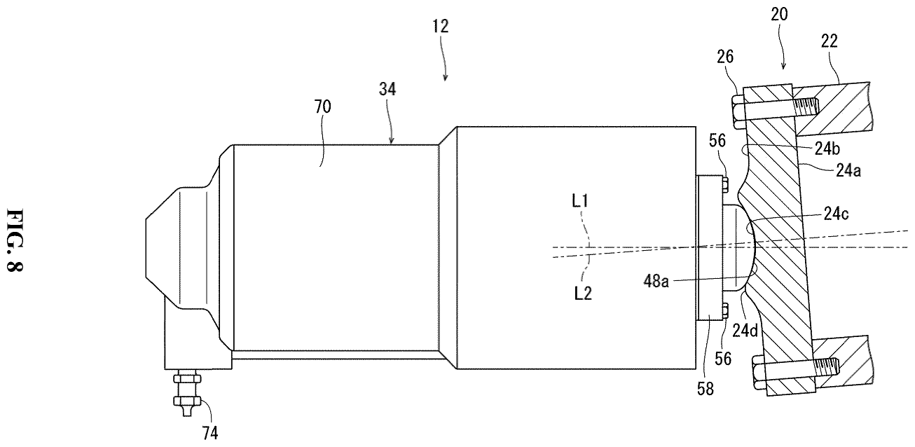

Referring to FIG. 8, in the illustrated embodiment, as described above, a concave surface 24c is formed on the connecting piece 24 of the idler yoke 20. Also, a convex surface 48a corresponding to the concave curved surface 24c is formed on the tip of the rod 48 of the piston rod 30. Then, the concave surface 24c and the convex surface 48a are in contact such that the position of the idler yoke 20 relative to the piston rod 30 is freely changed.

Therefore, when the track 10 is impacted, even if the idler 8 and the idler yoke 20 are tilted relative to the recoil device 12, the deviation of the idler yoke 20 relative to the recoil device 12 is absorbed.

A sign L1 in FIG. 8 represents a center line of the recoil device 12, and a sign L2 shows a center line of the idler yoke 20 and the idler 8. In addition, in FIG. 8, for convenience, a cross section is described for the idler yoke 20.

Also, in the present embodiment, since the concave surface 24c and the convex surface 48a are spherical, the three-dimensional deviation of the idler yoke 20 relative to the recoil device 12 is absorbed. Furthermore, the annular protrusion 24d suppresses the convex surface 48a from detaching from the concave surface 24c.

In contrast to the above-described form, a concave surface may be formed on the tip of the rod 48, and a convex surface corresponding to the concave surface may be formed on the connecting piece 24 of the idler yoke 20.

As described above, in the recoil device 12, the impact of the track 10 can be buffered by the action of a fluid, and since the accumulator 32 is protected by the cover member 34, damage to the accumulator 32 can be prevented.

In addition, in the recoil device 12 of the present embodiment, the tension of the track 10 can be adjusted by increasing or decreasing the amount of grease in the grease chamber 82.

Like the recoil device 12 of the present embodiment, if the movable distance D of the piston rod 30 can be changed and the rebound force of the track 10 when impacted can be adjusted, it can be carried on multiple tracked vehicles of different sizes and weights. -16-Furthermore, in a tracked vehicle comprising the traveling body 2, the deviation of the idler yoke 20 relative to the recoil device 12 can be absorbed.

### First Variant of Stroke Adjustment Means

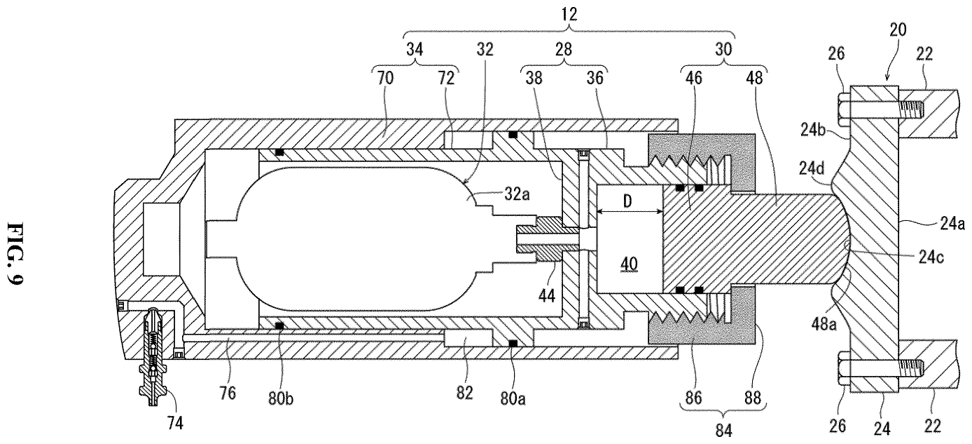

The stroke adjustment means for adjusting the movable distance D of the piston rod 30 are not limited to the above-described forms, and various forms may be employed. For example, the stroke adjustment means 84 of the first variant shown in FIG. 9 is movably and threadedly coupled to the cylinder tube 28 so that the movable distance D of the piston rod 30 is changed by changing the position of the stroke adjustment means 84 relative to the cylinder tube 28.

The first variant shown in FIG. 9 will be described in detail. A male thread extending along the X-axis direction is formed on the outer circumferential surface of the sidewall 36 of the cylinder tube 28. As in the first variant, the cylinder tube 28 may be integrally formed with the movable cover 72 of the cover member 34.

The stroke adjustment means 84 has a cylindrical sidewall 86 and an annular wall 88 provided at an end of the sidewall 86. A female thread is formed on the inner peripheral surface of the sidewall 86. The inner diameter of the annular wall 88 is approximately the same as the diameter of the rod 48 and is smaller than the diameter of the piston 46. The piston rod 30 is cylindrical, and no through hole is formed.

In the first variant, the rod cover 58 is not provided, unlike the form described above. However, the annular wall 88 of the stroke adjustment means 84 prevents the piston rod 30 from escaping from the cylinder tube 28. Although not shown, an appropriate rod packing is mounted on the annular wall 88.

The male thread of the sidewall 36 of the cylinder tube 28 and the female thread of the sidewall 86 of the stroke adjustment means 84 are then fitted so that the stroke adjustment means 84 are movably and threadedly coupled to the cylinder tube 28 in the X-axis direction.

In the first variant, the stroke adjustment means 84 can be moved in the X-axis direction relative to the piston rod 30 by rotating the stroke adjustment means 84 relative to the cylinder tube 28 before assembling the recoil device 12 to the travelling body 2.

In this way, since the amount of protrusion of the piston rod 30 from the cylinder tube 28 can be changed by changing the position of the stroke adjustment means 84 in the X-axis direction, the movable distance D of the piston rod 30 in the cylinder tube 28 can be adjusted.

### Second Variant of Stroke Adjustment Means

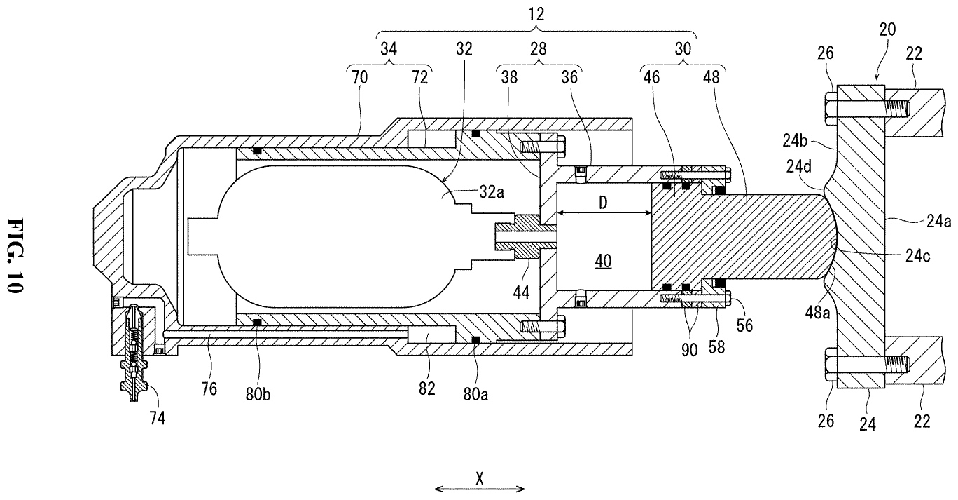

As shown in FIG. 10, the stroke adjustment means may be a spacer 90 fixed to the cylinder tube 28. Specifically, the spacer 90 is fixed to the end of the sidewall 36 of the cylinder tube 28 (the end on the side of the rod cover 58). The spacer 90 is fastened to the sidewall 36 by the bolt 56 together with the rod cover 58.

The spacer 90 shown in FIG. 10 is annular, and the inner diameter of the spacer 90 is approximately the same as the inner diameter of the sidewall 36 of the cylinder tube 28. Therefore, when the spacer 90 is provided between the cylinder tube 28 and the rod cover 58, the distance of the cylinder tube 28 in the X-axis direction is longer as compared with the case where the spacer 92 is absent, and thus the movable distance D of the piston rod 30 is longer.

Although FIG. 10 illustrates an example in which two spacers 90 having the same thickness are provided, the quantity and thickness of the spacers 90 are optional. The amount of increase in the movable distance D can be adjusted by adjusting the quantity and thickness of the spacer 90 as appropriate.

Still in the second variant shown in FIG. 10, as in the first variant shown in FIG. 9, the piston rod 30 is cylindrical and no through hole is formed.

### Third Variant of Stroke Adjustment Means

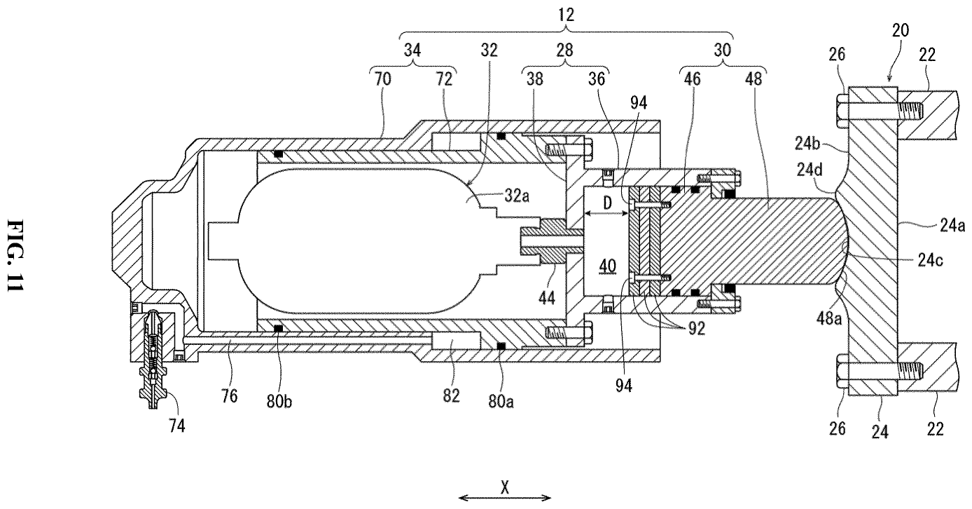

The stroke adjustment means may be a spacer 92 fixed to the piston rod 30, as shown in FIG. 11. Specifically, the spacer 92 is fastened by a bolt 94 to the end face of the piston 46 of the piston rod 30.

The spacer 92 shown in FIG. 11 is discoid, and the diameter of the spacer 92 corresponds to the diameter of the piston 46. However, the diameter of the spacer 92 may not correspond to the diameter of the piston 46. The shape of the spacer 92 may also be other shapes (e.g., a rectangular shape) rather than circular shapes.

Then, as shown in FIG. 11, since the spacer 92 is fixed to the end surface of the piston 46, the movable distance D of the piston rod 30 is reduced as compared with the case where the spacer 92 is not present.

In the third variant, as in the second variant, the quantity and thickness of the spacer 92 are optional, and the amount of reduction in the movable distance D can be adjusted by adjusting the quantity and thickness of the spacer 92 as appropriate. Also, in the third variant, the piston rod 30 is cylindrical and no through hole is formed.

1. A recoil device for buffering impact received by a track, the recoil device comprising:
a cylinder tube for storing liquid;
a piston rod slidably mounted on one end of the cylinder tube;
an accumulator connected to the other end of the cylinder tube; and
a cover member that protects the accumulator.

2. The recoil device of claim 1, wherein the cover member is capable of adjusting a tension of the track by moving the cylinder tube and the piston rod.

3. The recoil device of claim 1, wherein the cover member comprises a cylindrical fixed cover and a cylindrical movable cover slidably fitted to the fixed cover and connected to the cylinder tube;
a grease chamber for storing grease is formed between the fixed cover and the movable cover;
a tension of the track is adjusted by moving the movable cover relative to the fixed cover and by moving the cylinder tube and the piston rod due to an increase or decrease in an amount of grease in the grease chamber.

4. The recoil device of claim 1, further comprising a stroke adjustment means for adjusting a movable distance of the piston rod.

5. The recoil device of claim 4, wherein the stroke adjustment means is movably and threadedly coupled to the piston rod or the cylinder tube, and the movable distance of the piston rod is changed by changing the position of the stroke adjustment means.

6. The recoil device of claim 5, wherein a male thread is formed in the stroke adjustment means and a female thread is formed in the piston rod;
the stroke adjustment means is movably and threadably coupled to the piston rod by engaging the male thread and the female thread.

7. The recoil device of claim 5, wherein a male thread is formed in the cylinder tube and a female thread is formed in the stroke adjustment means;
the stroke adjustment means is movably and threadably coupled to the cylinder tube by engaging the male thread and the female thread.

8. The recoil device of claim 4, wherein the stroke adjustment means is a spacer fixed to the piston rod or the cylinder tube.

9. A tracked vehicle comprising the recoil device of claim 1, comprising:
a track frame, a sprocket disposed at one end of the track frame, an idler disposed at the other end of the track frame, and an idler yoke rotatably supporting the idler,
wherein one of the idler yoke and the piston rod is formed with a concave surface;
the other of the idler yoke and the piston rod is formed with a convex surface corresponding to the concave surface; and
the concave surface and the convex surface are in contact such that a position of the idler yoke relative to the piston rod is freely changeable.

10. The tracked vehicle of claim 9, wherein the concave surface and the convex surface are both spherical.

11. The tracked vehicle of claim 9, wherein an annular protrusion is provided around the concave surface.
